(19) United States
(12) Patent Application Publication
(10) Pub. No.: US 2006/0129684 A1
(43) Pub. Date: Jun. 15, 2006

(54) Apparatus and method for distributing requests across a cluster of application servers

(75) Inventor: Anindya Datta, Atlanta, GA (US)

Correspondence Address: GARDNER GROFF SANTOS & GREENWALD, P.C., 2018 POWERS FERRY ROAD, SUITE 800, ATLANTA, GA, 30339, US

(73) Assignee: Chutney Technologies, Inc.

(21) Appl. No.: 10/985,118

(22) Filed: Nov. 10, 2004

(51) Int. Cl. G06F 15/16

(52) U.S. Cl. 709/229

(57) ABSTRACT

A method and apparatus for distributing a plurality of session requests across a plurality of servers. The method includes receiving a session request and determining whether the received request is part of an existing session. If the received request is determined not to be part of an existing session, then the request is directed to a server having the lowest expected load. If, however, the request is determined to be part of an existing session, then a second determination is made as to whether the server owning the existing session is in a dispatchable state. If the server is determined to be in a dispatchable state, then the request is directed to that server. However, if the server is determined not to be in a dispatchable state, then the request is directed to a server other than the one owning the existing session that has the lowest expected load.

### TECHNICAL FIELD OF THE INVENTION

The invention relates to an apparatus and method for distributing requests across a cluster of application servers for execution of application logic.

### BACKGROUND OF THE INVENTION

Modern application infrastructures are based on clustered, multi-tiered architectures. In a typical application infrastructure, there are two significant request distribution points. First, a web switch distributes incoming requests across a cluster of web servers for HTTP processing. Subsequently, these requests are distributed across the application server cluster for execution of application logic. These two steps are referred to as the Web Server Request Distribution (“WSRD”) step and the Application Server Request Distribution (“ASRD”) step, respectively.

The bulk of ASRD in practice is based on a combination of Round Robin (“RR”) and Session Affinity routing schemes drawn directly from known WSRD techniques. More specifically, the initial requests of sessions (e.g., the login request at a web site) are distributed in a RR fashion, while all subsequent requests are handled through Session Affinity based schemes, which route all requests in a particular session to the same application server. Session state, which stores information relevant to the interaction between the end user and the web site (e.g., user profiles or a shopping cart), is usually stored in the process memory of the application server that served the initial request in the session, and remains there while the session is active. By routing requests to the application server “owning” the session, Client/Session Affinity routing schemes can avoid the overhead of repeated creation and destruction of session objects. However, these routing schemes often result in severe load imbalances across the application cluster, due primarily to the phenomenon of the convergence of long-running jobs in the same servers.

Also when combining RR approaches with Session Affinity approaches, another issue arises: the lack of session failover. The session failover problem occurs because a session object resides on only one application server. When an application server fails, all of its session objects are lost, unless a session failover scheme is in place.

Therefore, there exists in the industry a need for a request distribution method that distributes requests across a cluster of application servers, while enabling session failover, such that the load on each application server is kept below a certain threshold and session affinity is preserved where possible.

### SUMMARY OF THE INVENTION

Briefly described, the present invention is a method for distributing a plurality of session requests across a plurality of servers. The method includes receiving a session request and determining whether the received request is part of an existing session. If the received request is determined not to be part of an existing session, then the request is directed to a server having the lowest expected load. If, however, the request is determined to be part of an existing session, then a second determination is made as to whether the server owning the existing session is in a dispatchable state. If the server is determined to be in a dispatchable state, then the session request is directed to that server. However, if the server owning the existing session is determined not to be in a dispatchable state, then the session request is directed to a server other than the one owning the existing session that has the lowest expected load. Thus, preferably, the session request is directed to an “affined” dispatchable server (i.e., the server where the immediately prior request in the session was served).

In one aspect, the present invention is an apparatus for distributing a plurality of session requests across an application cluster. The apparatus comprises logic configured to determine whether the received session request is part of an existing session. If the received session request is determined not to be part of an existing session, then the logic directs the session request to a different server that has a lowest expected load. However, if the received session request is determined to be part of an existing session, then the logic makes a second determination as to whether the server owning the existing session is in a dispatchable state. If a determination is made that the server is in a dispatchable state, then the logic directs the session request to that server. However if a determination is made that the server is not in a dispatchable state, then the logic directs the session request to a different server that has a lowest expected load.

In another aspect, the present invention is a request distribution method that follows a capacity reservation procedure to judge loading levels. To provide an example of this, it will be assumed that an application server Aₖ exists that currently is processing y sessions. It will also be assumed that it is desired to keep the server under a throughput of T. Further, it will be assumed that it takes h seconds, on average, between subsequent requests inside a session (this is referred to as think time) and that the system, at any given time, considers the state of this application server G seconds into the future. Given this information, for tractability, the lookahead period G is partitioned into C distinct time slices of duration d. Such partitioning allows judgments to be made effectively. Given that the goal of the task is to compute a decision metric (throughput in this case), it is easier, more reliable and thus preferable, to monitor this metric over discrete periods of time, rather than performing continuous dynamic monitoring at every instant.

The capacity reservation procedure can be explained as follows. Given that there are y sessions in the current time slice, it is assumed that each of these sessions will submit at least one more request. These requests are expected to arrive in a time slice h units of time away from the current slice, in time slice cₕ. This prompts reserving capacity for the expected request in this application server in cₕ. More particularly, anytime a request r arrives at an application server Aₖ at time t, assuming that this request belongs to a session S, a unit of capacity on Aₖ is reserved for the time slice containing the time instant t+h. It should be noted that this reflects the desire to preserve affinity in that it assumes that all requests for session S will, ideally, be routed to Aₖ. Such rolling reservations provide a basis for judging expected capacity at an application server. When it is desired to dispatch a request, assuming dispatching the request to the affined server is not possible, a check is made to the different application servers in the cluster to see which ones have the property that the amount of reserved capacity in the current time slice is under the desired maximum throughput T, and the least loaded among the servers is chosen.

In accordance with the preferred embodiment, preferably the capacity reservation procedure takes into account various other issues, e.g., the fact that the current request may actually be the last request in a session (in which case the reservation that has been made is actually an overestimation of the capacity required), as well as the fact that the think time for a particular request may have been inaccurately estimated.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows an application infrastructure for thread virtualization in accordance with an exemplary embodiment of the present invention.

FIG. 2 is a graph that shows a typical throughput curve for an application server as load is increased.

FIG. 3 is a block diagram of a portion of the architecture for distributing requests across a cluster of application servers.

FIG. 4 is a flowchart representation of the request distribution method of the present invention.

FIG. 5 is a schematic view of a cycle of time slices used in accordance with an exemplary embodiment of the present invention.

FIG. 6 is a linear view of a partial cycle of time slices.

### DETAILED DESCRIPTION OF THE PREFERRED EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise.

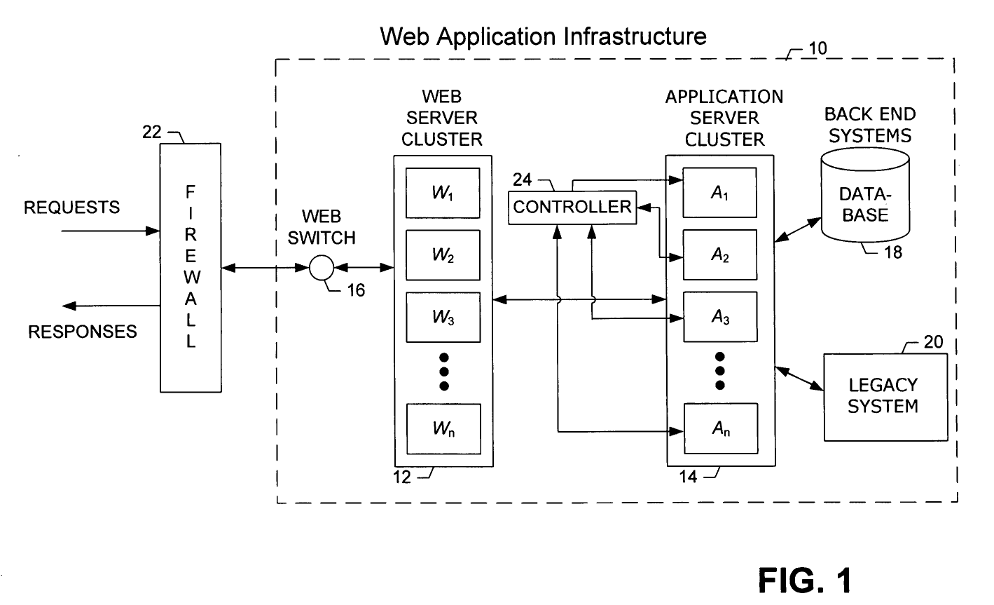

FIG. 1 shows an application infrastructure 10 for thread virtualization in accordance with an exemplary embodiment of the present invention. The phrase “thread virtualization” used herein refers to a request distribution method for distributing requests across a group of application servers, e.g., a cluster. The application infrastructure includes a cluster 12 of web servers W, a cluster 14 of application servers A, and a web switch 16. The application infrastructure 10 also has back end systems including a database 18 and a legacy system 20. Optionally, requests to the infrastructure 10 and responses from the infrastructure 10 pass through a firewall 22. Additionally, a controller 24 communicates with at least one of the application servers A.

As depicted in FIG. 1, a set of application servers A={A₁, A₂, . . . , Aₙ} is configured as a cluster 12, where the cluster is a set of application servers configured with the same code base, and sharing runtime operational information (e.g., user sessions and Enterprise JavaBeans (“EJBs”)). For simplicity, each application server Aₖ (k=1, . . . , n) is assumed to be identical, although heterogeneous application servers can be employed as well. A request r is a specific task to be executed by an application server. Each request is assumed to be part of a session, S, where a session is defined as a sequence of requests from the same user or client. In other words, S=<r_{1,S}, r_{2,S}, . . . , r_{s,S}>, and r_{j,S} denotes the j^{th} request in S. A set of web servers W={W₁, W₂, . . . , Wₙ} is configured as a cluster 14 and dispatches application requests to the application servers in the cluster 12.

Also preferably, the web application infrastructure includes at least one computer, connected to the cluster of servers A, for distributing one or more session requests r across the cluster of servers. The computer has at least one processor, a memory device coupled to the processor for storing a set of instructions to be executed, and an input device coupled to the processor and the memory device for receiving input data including the plurality of session requests r. The computer is operative to execute the set of instructions.

The computer in conjunction with the set of instructions stored in the memory device includes logic configured to determine whether the received session request r is part of an existing session. If the received session request r is determined not to be part of an existing session, then the logic directs the session request r to a different server that has a lowest expected load. If, however, the received session request r is determined to be part of an existing session, then the logic makes a second determination as to whether the server owning the existing session is in a dispatchable state. If a determination is made that the server is in a dispatchable state, then the logic directs the session request r to that server. If, however, a determination is made that the server is not in a dispatchable state, then the logic directs the session request r to a different server that has a lowest expected load.

Preferably, the logic directs the session request to a server that has the lowest expected load by obtaining a load metric for more than one of the plurality of servers, comparing the load metrics of the plurality of servers, and determining which server of the cluster of servers has the lowest expected load based on the comparison of the load metrics of the cluster of servers. Also preferably, the logic determines whether the server owning the existing session to which the session request is part of is in a dispatchable state by obtaining an actual load of the server owning the existing session, retrieving a maximum acceptable load of the server owning the existing session, comparing the actual load of the server to the maximum acceptable load of the server, and determining whether the server is in a dispatchable state based on the comparison of the actual load of the server to the maximum acceptable load of the server.

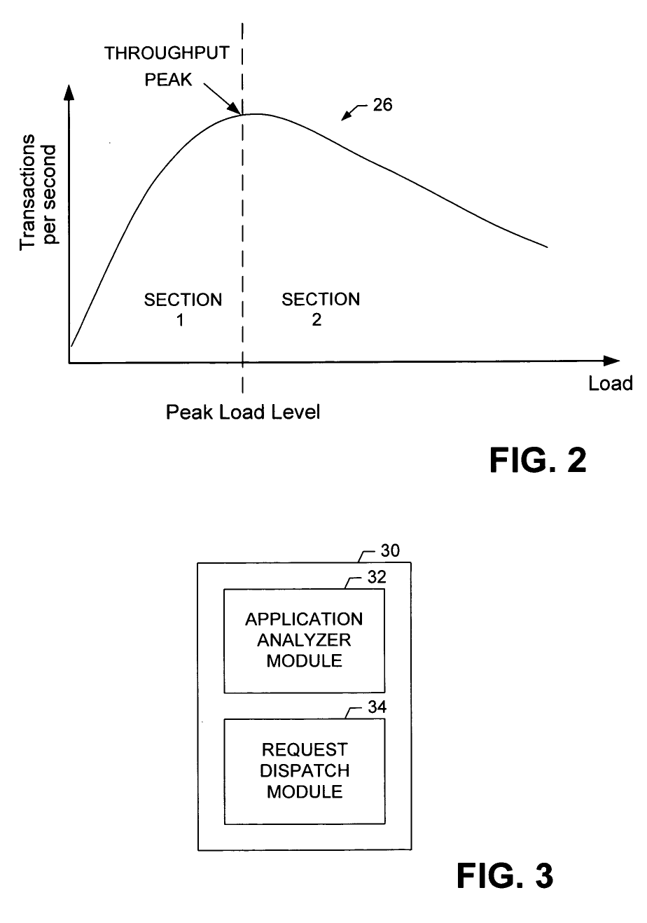

As described herein, an application server A can be in one of two states: lightly-loaded or heavily loaded. FIG. 2 is a graph that shows a typical throughput curve 26 for an application server as load is increased. Section 1 of the graph represents a lightly loaded application server, for which throughput increases almost linearly with the number of requests. This behavior is due to the fact that there is very little congestion within the application server system queues at such light loads. Section 2 represents a heavily loaded application server, for which throughput remains relatively constant as load increases. However, the response time increases proportionally to the user load due to increased queue lengths in the application server. Thus, as soon as this peak throughput point or saturation point is reached, application server performance degrades. The load level corresponding to this throughput point will be referred to herein as the peak load.

Also in accordance with the request distribution method of the present invention, a given application server is treated as either dispatchable or non-dispatchable. A dispatchable application server corresponds to a lightly loaded server, while a non-dispatchable application server corresponds to a heavily loaded application server. One of the goals of the request distribution method of the present invention is to keep all application servers under “acceptable” throughput thresholds, i.e., to keep the server cluster in a stable state as long as possible rather than to balance load per se. Load balancing is an ancillary effect, as discussed in more detail herein. Here, “balanced load” refers to the distribution of requests across an application server cluster such that the load on each application server is approximately equal.

A portion 30 of the architecture for thread virtualization includes two main logical modules: an application analyzer module 32 and a request dispatcher module 34, as depicted in FIG. 3. The application analyzer module 32 is responsible for characterizing the behavior of an application server. This application analyzer module 32 is intended to be run in an offline phase to record the peak throughput and peak load level for each application server under expected workloads—effectively, drawing the curve in FIG. 2 for each application server. This is achieved by observing each application server as it serves requests under varying levels of load, and recording the corresponding throughput values. These values are then used at runtime by the request dispatcher module 34.

The request dispatcher module 34 is responsible for the runtime routing of requests to a set of application servers by monitoring expected and actual load on each application server. In accordance with an exemplary embodiment of the present invention, the request dispatcher module 34 employs a method 40 of distributing requests across an application server cluster. The modules 32 and 34 can be located in the front end of one or more application servers A. Alternately or additionally, the modules 32 and 34 can be centrally located as part of the controller 24, which is in communication with at least one or more applications servers. It will be understood by those skilled in the art that the functions ascribed to the modules 32 and 32 can be implemented in software, hardware, firmware, or any combination thereof.

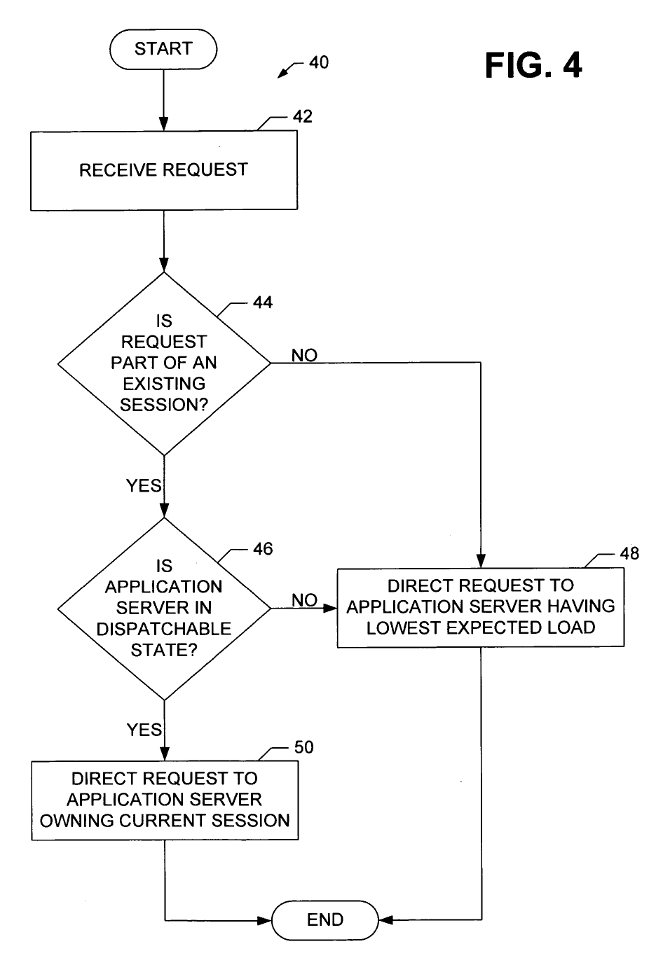

Referring to FIG. 4, the method 40 begins at step 42 when a request to be dispatched is received. At step 44, the request dispatcher module 34 makes a determination if the request is part of an existing session. In other words, the request dispatcher module 34 first attempts to send the request to an “affined” dispatchable server (i.e., the server where the immediately prior request in the session was served). If the request dispatcher module 34 determines that the request is part of an existing session, a determination is made at step 46 as to whether the application server is in a dispatchable state. If, at step 44, the request dispatcher module 34 determines that the request is not part of an existing session, the request dispatcher module 34 directs the request to the application server having the least expected load at step 48. If, at step 46, the application server is in a dispatchable state, the request dispatcher module 34, at step 50, directs the request to the application server owning the current session. If, however at step 46, the application server is not in a dispatchable state, the request dispatcher module 34 directs the request to the application server having the least expected load. Once the request dispatcher module 34 directs the request to an appropriate application server, the method 40 ends.

Thus, requests that initiate a new session are preferably routed to the least loaded application server. Also preferably, there is a session clustering mechanism in place to enable session failover. For example, a standard session clustering mechanism is provided with a standard, commercial application server, either as a native feature or through the use of a database management system (“DBMS”). Two standard failover schemes include session replication, in which session objects are replicated to one or more application servers in the cluster, and centralized session persistence, in which session objects are stored in a centralized repository (such as a DBMS).

The following terms, as applied to the present invention, are defined. Think time (h) is defined as the time between two subsequent requests r_{j,S} and r_{j+1,S} and is measured in seconds. Think time is computed as a moving average of the time between subsequent requests from the same session arriving at the cluster. The moving average considers the last g requests arriving at the cluster, where g represents the window for the moving average and is a configurable parameter.

A time slice (cᵢ) is defined to be a discrete time period of duration d (in seconds, where d is greater than the time to serve an application request) over which measurements are recorded for throughput on each application server. Preferably, there is a finite number of such time slices, C={c₀, c₁, . . . ,c_{C-1}}, where c₀ represents the current time slice, each cᵢ (i=0, . . . ,C-1) represents the i^{th} time slice, and C allows sufficient time slices for reservations h seconds in the future, i.e.,

$$C = ⌈ \frac{h}{d} ⌉ .$$

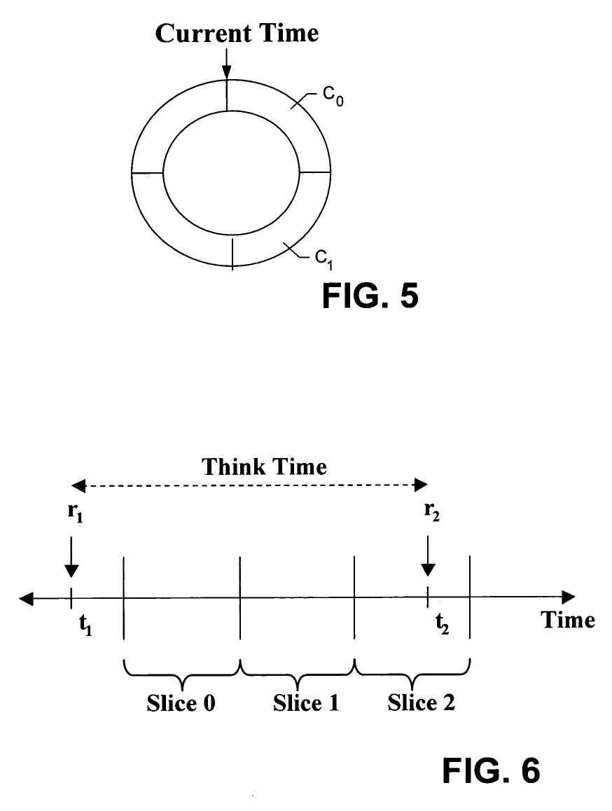

The C time slices are organized in a cycle of time slices for each application server, as shown in FIG. 5. Each time slice has an associated set of two load metrics, actual load and expected load, which are updated as new requests arrive and existing requests are served.

The actual load (l^{t}ₖ) of an application server Aₖ at time t is defined as the number of requests arriving at Aₖ within a time slice cᵢ, such that tεcᵢ. (Note that the t superscripts are dropped when t is implicit from the context.)

When a request rⱼ of a session S arrives at time tₚ, the predicted time slice c_{q} of the subsequent request in the session, i.e., rⱼ₊₁, is the time slice containing the time instant tₚ+h such that the request rⱼ₊₁ is predicted to arrive at the time instant tₚ₊ₕ.

The expected load (e^{k}ᵢ) of an application server Aₖ for the time slice cᵢ is defined as the number of requests expected to be served by Aₖ during the time slice cᵢ. Expected load is determined by accumulating the number of requests that a given application server should receive during cᵢ based on the predicted time slices for future requests for each active session associated with Aₖ.

FIG. 6 illustrates how expected load is determined by showing a linear view of a partial cycle of time slices. Each time slice has an expected load counter. For instance, consider the cycle for Aₖ. Here, e^{k}₀ represents the expected load counter for the current time slice (c₀), e^{k}₁ the expected load counter for time slice c₁, and so on. Suppose that request r₁ in a particular session occurred at time t₁, as shown in the figure. From the think time (h), the time slice in which request r₂ is expected to arrive can be determined. Suppose that, based on the think time, it is determined that request r₂ will arrive at time t₂, which occurs in time slice c₂ (refer to FIG. 6). Then e^{k}₂, the expected load for time slice c₂, is incremented by one. This effectively reserves capacity for this request on Aₖ during c₂.

Since predicted time slices are not guaranteed to be correct, the expected load can be adjusted to account for incorrect predictions. For example, an incorrectly predicted request may arrive either in a time slice prior to its predicted time slice or in a time slice subsequent to its predicted time slice. In the former case, the expected load counter for the predicted time slice is decremented upon observing the arrival of the request in the current time slice. For example, referring to FIG. 6, suppose that request r₂ actually arrives during the current time slice (c₀). In this case, the actual load for the current time slice (l) is incremented, while the expected load for time slice c₂ (e^{k}₂) is decremented. This effectively cancels the reservation for this request on the application server during the future time slice.

To account for cases where a request arrives subsequent to its predicted time slice, a modified load metric, mₖ, for application server Aₖ is used as an estimate that this type of error will occur with a certain frequency. The modified load metric is defined as mₖ=l^{t}ₖ+αae^{k}₀, where α(0<α≦1) is an expected load factor which adjusts for requests that arrive after their predicted time slices.

In a single web server environment, for a given application server, an expected load counter is maintained for each time slice. For the current time slice, the actual load is recorded by observing the number of requests served by the application server. Then, the modified load is computed for the current time slice by summing the actual load and the adjusted expected load (adjusted to account for prediction errors).

In a multi-web server environment, each web server runs its own instance of the request dispatcher 34. Thus, each request dispatcher 34 accesses the same global view of load metrics. To accomplish this, each request dispatcher 34 maintains a synchronized copy of the global view of load metrics. This global view is updated via a multicast synchronization scheme, in which each request dispatcher 34 periodically multicasts its changes to all other request dispatcher instances. This data sharing scheme allows all request dispatcher instances to operate from the same global view of load on the application servers, and yet allows each instance to act autonomously. Another issue that arises in a multi-web server environment is computing think time given that subsequent requests from the same session may be sent to a different web server. To address this issue, each web server, upon sending an HTTP response, records the time that the response is sent in a cookie. Thus, if a subsequent request from this session is sent to a different web server, the new web server can retrieve the time of the last response and use it to compute think time.

The request distribution method of the present invention utilizes two primary data structures: the TimeSlice array, denoted by TS[C], and the LoadMetrics array, denoted by LM[n][C]. TS[C] is a global array that stores the time ranges for each time slice cᵢ (i=1 . . . C) and is used to map timestamps into time slices. TS[i] stores the beginning and ending timestamps for time slice cᵢ. LM[n][C] is a global array containing the load metrics for each application server Aₖ(k=1 . . . n) and each time slice cᵢ (i=1 . . . C). Thus, LM[n][C] represents the global view of the load metrics. For application server Aₖ and time slice cᵢ, LM.e[k][i] denotes the actual load value, LM.m[k][i] denotes the modified load value, and LM.e[k][i] denotes the expected load value. Note that in the preferred embodiment, the actual load (lₖ) and modified load (mₖ) are stored for the current time slice (i=0). There are also two sorted lists of application servers maintained, one sorted by actual load (lₖ), and the other sorted by modified load (mₖ).

To maintain consistency of the global view of load metrics across the request dispatcher instances, a multicast synchronization scheme is employed for this purpose. Periodically, each request dispatcher 34 multicasts the changes it has recorded during the multicast period to all other request dispatchers. A request dispatcher 34, upon receiving such changes, applies them to its copy of the global view.

It should be noted that this synchronization scheme adds very little overhead to the system, both in terms of network communications overhead and processing overhead. The communications overhead depends on the number of web servers, the number of time slices, and the storage space needed for the load metrics. For example, consider an application environment having fifty web servers and a think time (h) of 60 seconds. If we assume a time slice duration (d) of 5 seconds, then the number of time slices (C) is 60/5=12. Each load metric value can be stored as a 1-byte integer. Since there is only a single value for actual load, it requires transmitting 1 byte to fifty web servers, and thus incurs 50 bytes of synchronization overhead. Transmitting expected load requires sending 12 bytes (1 byte for each time slice) to fifty web servers, incurring 600 bytes of synchronization overhead. Thus, the total synchronization overhead incurred for a web server is 650 bytes per transmission. If a multicast interval of 1 second is assumed, then the maximum overhead possible at any given time is 32.5 Kbps. This accounts for about only 0.03% of the total capacity of a 100 Mbps network (and far less on gigabit networks, which are becoming increasingly prevalent in enterprise application infrastructures).

With regard to processing overhead, a given request dispatcher performs n×C operations to apply the updates it receives from another request dispatcher. Since each request dispatcher applies the changes it receives to its own copy of the global view array, there is no locking contention.

Below are exemplary algorithms each request dispatcher 34 follows in dispatching requests to application server instances.

Algorithm 1 Application Server Request Distribution (ASRD) Algorithm

Select:

r_{j,S}: the j^{th} request in session S (j ≧ 1)
timestampₚ: timestamp of predicted time slice for r_{j,S}
d: duration of time slice (in seconds)
h: think time (in seconds)
TS[C]: global array of time ranges for time slices
LM[n][C]: global array of load metrics for application servers across time slices
α: expected load factor (0 < α ≦ 1)

1: Aₖ = NULL /* initialize */
2: Aₖ = SessionAffinity(r_{j,S}) /* attempt to assign affined server */
3: if Aₖ is NULL then
4: Aₖ = LeastLoaded(r_{j,S}) /* assign least loaded server */
5: UpdateLoadMetrics(r_{j,S}, timestampₚ, h, Aₖ) /* update load metrics to reflect
assignment of Aₖ to r_{j,S} */
6: AdvanceTimeSlice( ) /* advance time slice if necessary */
7: return Aₖ

Algorithm 1 includes the formal algorithm description for the application server request distribution method of the present invention. The inputs include r_{j,S}, the j^{th} request in session S, think time (h), duration of a time slice (d), and the expected load factor (α), in addition to the TS[C] and LM[n][C] arrays. The output is the assignment of request r_{j,S} to application server Aₖ. At a high level, the algorithm works as follows: given a request (r_{j,S}), the algorithm first attempts to assign the affined server to the request (line 2 of Algorithm 1). If the affined server is assigned, the algorithm then updates the load metrics to reflect this assignment (line 5). Next, a check is made to determine whether the time slice is to be advanced (line 6). Finally, the assigned application server Aₖ is returned (line 7). In the case where an affined server cannot be assigned, the algorithm attempts to assign the least loaded server (line 4). Additional details for the four referenced procedures in Algorithm 1 are provided in Algorithms 2 through 5, respectively.

Algorithm 2 SessionAffinity Procedure

Select:

r_{j,S}: the j^{th} request in session S (j ≧ 1)

1: Aₖ = GetAffinedServer(r_{j,S}) /* get server owning the session */
2: load = GetActualLoad(Aₖ) /*get actual load for current time slice */
3: T = GetMaxThroughput(Aₖ) /*get maximum throughput value */
4: if load < dT then
5: return Aₖ

The SessionAffinity procedure (Algorithm 2) takes as input request r_{j,S} and returns the assigned application server Aₖ if able to assign the affined server, and NULL otherwise. For example, it may not be possible to assign an affined server to a request if request r_{j,S} is the first request in a session (i.e., j=1), or if assigning the affined server will cause the server to reach or exceed its maximum acceptable load. The algorithm first retrieves the affined server for the request (line 1), assuming that this information is stored in the session object and that a session tracking technique is used. Next, the actual load (lₖ) for the server is obtained (line 2). This value is retrieved from the LM.l[n][C] array, more specifically the LM.l[k][0] entry. Next, the maximum throughput value for the application server (T) is obtained (line 3). Recall that the application analyzer module 32 maintains this information. Finally, the actual (lₖ) and maximum acceptable loads (dT) are compared (line 4) and the server assignment made accordingly (line 5).

Algorithm 3 LeastLoaded Procedure

Select:

r_{j,S}: the j^{th} request in session S (j ≧ 1)

1: if(j == 1) then
2: /* new session */
3: Aₖ = GetLeastLoaded(modified) /* get least loaded server based on modified load
metric m */
4: else
5: /* existing session that cannot be assigned to affined server */
6: Aₖ = GetLeastLoaded(actual) /* get least loaded server based on actual load
metric lₖ */
7: return Aₖ

The LeastLoaded procedure (Algorithm 3) takes as input request r_{j,S} and returns the assigned application server Aₖ. This procedure first checks for new sessions to determine which server load metric to use in the assignment (line 1). For new sessions, the modified load metric (m) is used (line 3), whereas for existing sessions, the actual load metric (l) is used (line 6). The reason for this is that for new sessions, there is no history of the demand patterns for the session and therefore, it is preferable to account for prediction errors (as discussed herein). The GetLeastLoaded procedure retrieves the least loaded server from the appropriate sorted list of servers, depending on the input parameter (modified or actual). Note that if there are no dispatchable servers, the procedure assigns the least loaded non-dispatchable server.

Algorithm 4 UpdateLoadMetrics Procedure

Select:

r_{j,S}: the j^{th} request in session S (j ≧ 1)
timestampₚ: timestamp of predicted time slice for r_{j,S}
h: think time (in seconds)
Aₖ: application server Aₖ assigned to r_{j,S}

1: LM./[k][0] ++ /* increment actual load */
2: /* check for prediction errors to update expected load values */
3: TimeSliceIndex = GetTimeSliceIndex(timestampₚ) /* get time slice index for
predicted time slice */
4: if (TimeSliceIndex == 0) then
5: LM.e[k][0] −− /*prediction correct: decrement expected load in current time slice */
6: else
7: LM.e[k][TimeSliceIndex] −− /*prediction incorrect: decrement expected load in
future time slice */
8: LM.m[k][0] = LM./[k][0] + α LM.e[k][0] /* compute modified load */
9: timestampₚ = timestamp_{current} + h /* compute next predicted time slice */
10: TimeSliceIndex = GetTimeSliceIndex(timestampₚ) /* get time slice index for
predicted time slice */
11: LM.e[k][TimeSliceIndex] + + /* increment expected load for predicted time slice */
12: SortServersByActual( ) /* sort the servers according to /*/
13: SortServersByModified( ) /* sort the servers according to m */

The UpdateLoadMetrics procedure (Algorithm 4) takes as input request r_{j,S}, the timestamp of the predicted time slice for r_{j,S} (timestampₚ), think time (h), and Aₖ, the application server recently assigned to r_{j,S}, and updates the metrics stored in the LM[n][C] array. First, the actual load (lₖ) is incremented (line 1). Next, the expected load values are updated to account for prediction errors (lines 3-7). The GetTimeSliceIndex procedure (line 3) retrieves the index from the TS[C] array given a timestamp as input. If the predicted time slice is the current time slice (line 4), then the prediction was correct and the expected load for the current time slice is decremented (line 5). Otherwise, the prediction was incorrect and the expected load in the future time slice is decremented (line 7). Subsequently, the modified load (mₖ) is updated (line 8). Next, the new predicted time slice is computed based on think time (line 9) and used to increment the expected load for the new predicted time slice (line 11). Finally, the two sorted server lists are re-sorted to account for the updated load metrics (lines 12-13).

Algorithm 5 AdvanceTimeSlice Procedure

1: if timestamp_{current} ∉ (TS.BeginTS[0], TS.EndTS[0]) then
2: TimeSliceIndex = GetTimeSliceIndex(timestamp_{current}) /* get time slice index of
current time */
3: ShiftTimeSliceValues(TimeSliceIndex) /* shift values in TS array to advance */

The AdvanceTimeSlice procedure (Algorithm 5) is used to advance the time slice based on the current time. The AdvanceTimeslice procedure checks whether the current timestamp (timestamp_{current}) falls within the timestamp range of the current time slice (line 1). If it does, the procedure obtains the time slice index for the current time slice (line 2) and uses this to shift the values in the TS[C] array accordingly (line 3).

While the invention has been described with reference to preferred and exemplary embodiments, it will be understood by those skilled in the art that a variety of modifications, additions and deletions are within the scope of the invention, as defined by the following claims.

What is claimed is:

1. A method for distributing a plurality of session requests across a plurality of servers, the method comprising the steps of:
receiving at least one session request;
determining whether the received session request is part of an existing session; and
if so, determining whether the server owning the existing session to which the session request is part of is in a dispatchable state,
if so, directing the session request to the server owning the existing session to which the session request is part of, and
if not, directing the session request to a server that does not own the existing session to which the session request is part of and that has the lowest expected load,
if not, directing the session request to a server that has the lowest expected load.

2. The method as recited in claim 1, wherein the step of directing the session request to a server that has the lowest expected load further comprises the steps of:
obtaining a load metric for more than one of the plurality of servers,
comparing the load metrics of the plurality of servers, and
determining which server of the plurality of servers has the lowest expected load based on the comparison of the load metrics of the plurality of servers.

3. The method as recited in claim 2, wherein, if the received session request is the first request of a session, the obtained load metric for the plurality of servers further comprises a modified load metric, wherein the modified load metric is an actual load of the server modified by a factored expected load value.

4. The method as recited in claim 3, wherein, if the expected load value has been estimated inaccurately, the expected load value is updated and the modified load value is updated based on the updated expected load value.

5. The method as recited in claim 2, wherein, if the received session request is part of an existing session, the obtained load metric for the plurality of servers further comprises an actual load value of the server for the current time period.

6. The method as recited in claim 1, wherein the second determining step further comprises the steps of:
obtaining an actual load of the server owning the existing session,
retrieving a maximum acceptable load of the server owning the existing session,
comparing the actual load of the server to the maximum acceptable load of the server, and
determining whether the server is in a dispatchable state based on the comparison of the actual load of the server to the maximum acceptable load of the server.

7. The method as recited in claim 1, wherein the received session request has associated therewith at least one session object, and wherein the method further comprises the step of replicating the session objects associated with the received session request in a server other than the server owning the existing session.

8. The method as recited in claim 1, wherein the received session request has associated therewith at least one session object, and wherein the method further comprises the step of storing the session objects associated with the received session request in a centralized repository.

9. The method as recited in claim 1, wherein the received session request has associated therewith a user and wherein the existing session has associated therewith a user, and wherein the first determining step further comprises determining whether the user associated with the received session request and the user associated with the existing session are the same user.

10. The method as recited in claim 1, wherein the first determining step further comprises determining whether the received session request is the first request of/in a session.

11. The method as recited in claim 1, wherein the plurality of servers further comprises a cluster of application servers, and wherein at least one of the plurality or session requests further comprises an application request.

12. An apparatus for distributing a plurality of session requests across a plurality of servers, the apparatus comprising:
logic configured to determine whether the received session request is part of an existing session, and if not, directing the session request to a different server that has a lowest expected load, and if so, said logic making a second determination by determining whether the server owning the existing session is in a dispatchable state, and if so, directing the session request to said server, and wherein if a determination is made that said server is not in a dispatchable state, directing the session request to a different server that has a lowest expected load.

13. The apparatus as recited in claim 12, wherein the logic further
obtains a load metric for more than one of the plurality of servers,
compares the load metrics of the plurality of servers, and
determines which server of the plurality of servers has the lowest expected load based on the comparison of the load metrics of the plurality of servers.

14. The apparatus as recited in claim 12, wherein the logic further:
obtains an actual load of the server owning the existing session,
retrieves a maximum acceptable load of the server owning the existing session,
compares the actual load of the server to the maximum acceptable load of the server, and
determines whether the server is in a dispatchable state based on the comparison of the actual load of the server to the maximum acceptable load of the server.

15. The apparatus as recited in claim 12, further comprising an application analyzer module for characterizing the behavior of at least one of the plurality of servers by measuring the throughput and/or the peak load level of the server.

16. The apparatus as recited in claim 12, further comprising a request dispatcher for monitoring the actual load and/or the expected load of the server.

17. A computer program for distributing a plurality of session requests across a plurality of servers, the computer program being embodied on a computer readable medium, the program comprising:
code for receiving at least one session request;
code for determining whether the received session request is part of an existing session; and
if so, code for determining whether the server owning the existing session to which the session request is part of is in a dispatchable state,
if so, code for directing the session request to the server owning the existing session to which the session request is part of, and
if not, code for directing the session request to a server that does not own the existing session to which the session request is part of and that has the lowest expected load,
if not, code for directing the session request to a server that has the lowest expected load.

18. The computer program as recited in claim 17, further comprising code for
obtaining a load metric for more than one of the plurality of servers,
comparing the load metrics of the plurality of servers, and
determining which server of the plurality of servers has the lowest expected load based on the comparison of the load metrics of the plurality of servers.

19. The computer program as recited in claim 17, further comprising code for
obtaining an actual load of the server owning the existing session,
retrieving a maximum acceptable load of the server owning the existing session,
comparing the actual load of the server to the maximum acceptable load of the server, and
determining whether the server is in a dispatchable state based on the comparison of the actual load of the server to the maximum acceptable load of the server.

20. A web application infrastructure, comprising:
a plurality of servers; and
at least one computer, connected to the plurality of servers, for distributing a plurality of session requests across the plurality of servers, the at least one computer having:
at least one processor,
a memory device coupled to the at least one processor for storing at least one set of instructions to be executed, and
an input device coupled to the at least one processor and the memory device for receiving input data including the plurality of session requests,
wherein the at least one computer is operative to execute the at least one set of instructions, and the at least one set of instructions stored in the memory device in the at least one computer causing the at least one processor associated therewith to:
determine whether the received session request is part of an existing session; and
if so, determine whether the server owning the existing session to which the session request is part of is in a dispatchable state,
if so, direct the session request to the server owning the existing session to which the session request is part of,
if not, direct the session request to a server that does not own the existing session to which the session request is part of and that has the lowest expected load,
if not, direct the session request to a server that has the lowest expected load.

21. The system as recited in claim 20, wherein the instructions stored in the memory device in the computer further cause the at least one processor to:
obtain a load metric for more than one of the plurality of servers,
compare the load metrics of the plurality of servers, and
determine which server of the plurality of servers has the lowest expected load based on the comparison of the load metrics of the plurality of servers.

22. The system as recited in claim 20, wherein the instructions stored in the memory device in the computer further cause the at least one processor to:
obtain an actual load of the server owning the existing session,
retrieve a maximum acceptable load of the server owning the existing session,
compare the actual load of the server to the maximum acceptable load of the server, and
determine whether the server is in a dispatchable state based on the comparison of the actual load of the server to the maximum acceptable load of the server.

23. The system as recited in claim 20, wherein at least one of the plurality of servers and/or the at least one computer includes an application analyzer module for characterizing the behavior of at least one of the plurality of servers by measuring the throughput and/or the peak load level of the server.

24. The system as recited in claim 20, wherein at least one of the plurality of servers and/or the at least one computer includes a request dispatcher for monitoring the actual load and/or the expected load of the server.

25. The system as recited in claim 20, wherein at least a portion of the at least one computer resides in at least one of the plurality of servers.

26. The system as recited in claim 20, wherein the plurality of servers further comprises a cluster of application servers.

27. The system as recited in claim 20, wherein the plurality of servers further comprises:
a cluster of web servers, and
a cluster of application servers in communication with the cluster of web servers.
